(19) United States
(12) Patent Application Publication
(10) Pub. No.: US 2013/0158699 A1
(43) Pub. Date: Jun. 20, 2013

(54) METHOD FOR MONITORING THE MANUFACTURING PROCESS OF HOT-MANUFACTURED TUBES MADE FROM STEEL

(71) Applicant: V & M Deutschland GmbH, Dusseldorf (DE)

(72) Inventors: Gerd-Joachim Deppe, Krefeld (DE); Mark van der Logt, Essen (DE)

(73) Assignee: V & M DEUTSCHLAND GMBH, Dusseldorf (DE)

(21) Appl. No.: 13/709,406

(22) Filed: Dec. 10, 2012

(30) Foreign Application Priority Data
Dec. 14, 2011 (DE) 10 2011 056 421.7

(51) Int. Cl. G01B 11/24; B21B 37/28

(52) U.S. Cl. CPC G01B 11/24; B21B 37/28
USPC 700/148; 356/601

(57) ABSTRACT

A method for monitoring the manufacturing process of hot-rolled tubes in which the type and dimensional characteristics of structures produced by the rolling process on an outer surface of the tube are evaluated to assess the process state. Immediately subsequent to the rolling process in the exit side region of a rolling stand the outer surface of at least one defined portion of the tube is detected by measuring technology, linearly by means of an optical laser stripe method and in a clocked manner in the form of profile lines, and the profile lines are then combined to form an at least two-dimensional topography and the topography is evaluated to assess the process state.

### BACKGROUND OF THE INVENTION

The present invention relates to a method for monitoring the manufacturing process of hot-rolled tubes, in particular of steel tubes produced using the Pilger method, wherein the type and dimensional characteristics of structures produced by the rolling process on an outer surface of the tube are evaluated in order to assess the state of the process.

In the Pilger method or Pilger step-by-step method, a hollow body produced, for example, in a skew rolling mill is rolled to form a tube of extended length and with thin walls. In the Pilger rolling stand there are located two conically grooved rolls disposed one above the other which are driven in a direction opposite to the rolling direction. The thick-walled hollow body is introduced between these rolls on a cylindrical mandrel. The so-called Pilger work pass grasps the hollow body and shears off a small material wave from the outside, which is then stretched to the intended wall thickness by the smoothing pass on the Pilger mandrel. In dependence upon the rotational direction of the rolls, the Pilger mandrel with the hollow body located thereon is thus moved backwards—i.e. against the rolling direction—until the idle pass releases the rolled stock. During simultaneous rotation, the tube is brought by a further length between the rolls and the rolling process begins again.

Within the framework of monitoring the manufacturing process of hot-manufactured tubes, in particular hollow body tubes, amongst other things, conclusions about the process state or the stability of the rolling process should be reached as early as possible because the properties of the end product, i.e. of the finished tube are decisively influenced thereby.

Apart from the mechanical-technological material properties, in particular the topography of the rolled tube is a decisive quality parameter which is measured and monitored on the tube at different manufacturing stages in the production processes. The topography should be as free of failures as possible, i.e. should have a smooth surface adhering to the respective requirements.

However, when producing tubes by the Pilger method surface structures are produced, which are not critical as long as their diameter, shape and local depth are below given limits.

When producing tubes by the Pilger method, as well as e.g. by too large of an advancement, characteristic method-induced surface structures maybe produced which constitute so-called “Pilger humps”. These Pilger humps are undesirable and are manifested as three-dimensional patterns occurring periodically on the tube surface and which differ in their characteristic dimensions, such as their diameter, shape, and local depth, depending on the tube geometry to be rolled and the material to be rolled.

Apart from these continually occurring method-induced patterns on the tube surface, there are also non-continually occurring geometric deviations such as, e.g., eccentricity, one-sidedness in the wall or polygonality.

The Pilger process is known to be complex and is determined by a multiplicity of influential variables such as setting parameters and rolled stock. Some influential variables include the following:
feed rate per rotation
angle of twist
rotational speed
deceleration-acceleration in the front end point
deceleration-acceleration in the rear end point
roll pass design of the Pilger rolls and Pilger mandrels
static friction conditions between the tools and rolled stock
material

Although according to the known prior art there are “basic settings” for the rolling process depending upon the tube geometry to be produced and the material used, the rolling process itself is controlled by the control operator typically to a large degree on the basis of subjective observations during the course of the process, including on the basis of visual monitoring of the tube surface.

### SUMMARY OF THE INVENTION

With the conventional manner of proceeding, uniform monitoring of the process state and of the control of the manufacturing process cannot be effected. The present invention therefore provides an appropriately improved and—as far as possible—automated method that is easy and inexpensive to implement and by means of which it is possible to reach conclusions about the process state and/or the process stability of the rolling process as closely as possible to real time.

The method is further optimized in such a way that any events negatively influencing the process stability of the rolling process can be identified early and it thus becomes possible to correct the process in a targeted manner.

In accordance with an aspect of the present invention, in a method for monitoring the manufacturing process of hot-rolled tubes, in particular steel tubes produced by a hot Pilger process, in which the type and markedness of structures produced by the rolling process on an outer surface of the tube are evaluated to assess the process state, an improvement and—as far as possible—automation are achieved in that immediately subsequent to the rolling process in the exit side region of a rolling stand the outer surface of at least one defined portion of the tube is detected by measuring technology, linearly by means of an optical laser stripe method and in a clocked manner in the form of profile lines, the profile lines are then combined to form an at least two-dimensional topography and the topography is evaluated to assess the process state.

According to an aspect of the present invention, tube surface portions are detected continually by measuring technology directly at the exit of the last Pilger rolling stand with the aid of an optical laser stripe method in order to achieve contactless detection of the tube surface structure. According to a particular aspect, profile lines recorded individually one after the other in a linear manner are combined to form three-dimensional surface contours as the tube continues to move—typically a combination of axial and rotational movement comparable with the eponymous Pilger steps. Synchronisation of profile line detection and tube movement—in the form of an external triggering of the profile line detection by suitable two-dimensionally recorded path increment pulses—is required for a true-to-scale recording of the tube surface.

During the synchronisation it is possible for only certain movement phases of the tubes at the exit of the Pilger rolling stand to be optionally selected, including in a controlled manner, for recording.

The present invention relates to the optical profile measurement which takes place in a contactless manner according to the laser stripe method as a two-dimensional triangulation method which is known per se.

The innovative approach of the present invention consists of using the deductions as to process-induced causes, which result from the detection and evaluation of the surface topography, to monitor and control the rolling process.

During measurement and upon a relative movement taking place between the sensor and the measured object it is possible—by combination from the successive recorded “profile sections” as a height profile—to build up a two-dimensional contour of a profile composed thereof or—by evaluation of a plurality of peripheral contours and the profile length—to build up a three-dimensional topography of the outer contour of the measured object such as e.g. a tube.

The profile measurement considered within the framework of an aspect of the present invention is based in its one-dimensional form on the known point triangulation in which a laser and a linear position-sensitive detector form the triangulation sensor. The laser beam axis and optical axis of the detector span a plane designated as the “normal plane” and are positioned at the triangulation angle with respect to each other. In the conventional manner, the distance of the measured object from the sensor in the direction of the laser beam constitutes the measurement variable. This method is known e.g. from DE 40 37 383 A1.

During the two-dimensional extension of the point triangulation, the punctiform laser beam is replaced by a laser beam fan and the one-dimensional linear detector is replaced by a two-dimensional planar detector. The laser generates a laser beam fan as the measuring field, the beams of which scattered back from the surface of the object being checked are received and mapped by a lens and a two-dimensional planar detector. The lens and detector form a two-dimensionally operating surface image camera. The laser beam fan is typically generated by a diffractive lens mounted upstream of the punctiform laser beam output and thus generates a one-dimensional line designated as a “laser stripe line” on the measured object.

In a manner which is characteristic for the optical laser stripe method, the detection range and therefore generally the spatial resolution and the profile rate can be adapted e.g. to the tube diameter and tube speed.

In an improved development of the invention the detection and evaluation take place in an automated manner, wherein either specifications for corrections in the setting parameters are given to the control operator or the corrections take place automatically in a still further improved formation.

The method is thus supplemented by a specific pattern and size analysis of the recorded surface structures as a tool, with which it is possible to obtain suitable setting parameters for the Pilger rolling stand “online” directly during the rolling process. The analysis can take place in particular with respect to characteristic parameters of the recorded structures such as e.g. lateral expansion, depth, shape factors, periodicity or spacings.

The surface topography arising during discontinuous Pilger rolling is fundamentally periodical in the peripheral and longitudinal direction (recurring surface structure). With the aid of these structures a plurality of measurable effects can be deduced, which clearly can be traced back to the above-described parameters.

### EXAMPLE 1

The structures orientated in the peripheral direction must be disposed at regular radial angular distances from each other. If the measuring arrangement detects deviations from these regular structures, a control algorithm is used to regulate the twist angle dynamically.

### EXAMPLE 2

The structures occurring in the longitudinal direction must also be disposed at regular distances from each other. If the measured distances between these structures change over the tube length or if the structures exceed the required tolerances, the rotational speed and the feed rate, amongst other things, must be adapted by means of a control algorithm.

An early reaction and, if necessary, rapid correction of the setting parameters in order to optimise the rolling process are therefore possible.

Wide-ranging trials have shown that during the manufacture of tubes produced by a hot Pilger process there is a direct correlation between the detected surface topography and the current process state.

A manufacturing process which is becoming unstable is shown e.g. in a clear change in the periodically occurring structures in the quantitative and qualitative formation (shape, size and spacing) on the surface.

The outer surface of the tube is advantageously detected in a spatially-resolved and time-resolved manner and the topography composed therefrom is compared with a reference image of an already rolled tube, serving as a reference body, of the same steel grade class and same nominal dimensions of the same measurement location in each case and is evaluated to assess the process state. In so doing, any structures arising on the surface of the tube are determined from a topography of the tube at a specific measurement location, the determined structures are compared with structures of a topography of the reference body for the same measurement location and a significant deviation between the structures is evaluated to assess the process state.

The great advantage of this method is that it is now possible for a relatively low outlay in terms of measuring technology to detect the surface topography in a contactless manner directly at the exit of the Pilger rolling stand, whereby if any intolerable deviations occur it is possible to carry out a correction of the setting parameters immediately. Therefore merely by a qualitative and quantitative assessment of the structures of the topography of the tube surface it is possible to come to a substantiated conclusion about the current process state.

In a further embodiment, this method advantageously offers the possibility of establishing a tolerance range for flaws from a plurality of topographies previously determined using reference bodies of the same steel grade and diameter, a signal being triggered upon this tolerance range being exceeded by the determined actual deviations of the tube being manufactured.

By the detection of the surface topography in accordance with the invention, which topography is compared in real time during the process with the topographies detected on reference bodies, it is possible to assess the process stability or changes in the process stability and to initiate corresponding measures when established boundaries are exceeded.

Any events influencing the process stability, for which topographies were previously determined on corresponding reference tubes, can now be compared with the measured values of the current rolling process and the reference to the respective event can be produced when a tolerance boundary is exceeded.

In one embodiment the signal can advantageously be assigned to the measurement location on the tube and a reference to an event in the manufacturing process leading to the tolerance boundaries being exceeded can be produced.

The method can advantageously be further optimised in that the assignment of measuring signal and event, which is determined in each case for the finished tube, is stored in a database of the evaluation unit for each reference body of the same steel grade class, diameter and wall thickness, and, if the tolerance boundaries are exceeded, the event leading thereto is reported and used as a control variable for the manufacturing process.

By means of this self learning effect, an expert system is virtually built up which, with the continual storage of the assignment of the reported signal and the event which has taken place, makes possible increasingly more reliable and real time conclusions to be drawn for the respective tube about process stability and about the factors influencing the process stability.

Furthermore, the method lends itself to deriving corrective measures for the manufacturing process from this information in order finally to achieve the most constant production properties possible while manufacturing proceeds in the least disrupted manner possible.

In one advantageous embodiment of the method it is likewise possible also to determine the actual values of the wall thickness on the rolled tube. In so doing, the wall thickness of the tube is detected in a spatially resolved and time resolved manner directly after exit from the rolling mill e.g. by means of laser-ultrasound technology, and a depiction of the tube inner contour is generated by superimposing a similarly spatially resolved and time resolved detection of the surface topography. Therefore with this method the tube can additionally be investigated for changes on the inner surface so that e.g. wear on the mandrel bar can be recognised early.

With this innovative method for monitoring the manufacturing process of hot-manufactured tubes it is possible to monitor the rolling process, to correct it and to draw a conclusion about the whole wall thickness or wall thickness distribution of the finished tube.

Further features, advantages and details of the invention are given by the following description of the illustrated exemplified embodiments.

### BRIEF DESCRIPTION OF THE DRAWINGS

FIG. 1 is a schematic illustration of a device for carrying out the method in accordance with an embodiment of the invention for monitoring the manufacturing process of hot-manufactured tubes with the aid of online detection of the topography of the surface of the tubes by means of a laser stripe method; and

FIG. 2 is a detailed illustration of a detected flaw on the surface of the tube.

### DESCRIPTION OF THE PREFERRED EMBODIMENTS

In the method in accordance with the invention, a checking device consisting of a measuring or detection unit is fixedly disposed and the tube moves along thereunder in the longitudinal and/or peripheral direction. The checking device may be advantageously located directly at the exit of the rolling stand in order to be able, in the most real time manner possible, to recognise possible deviations from the desired topography of the tube and to initiate remedial measures.

In the case of continuous rolling methods, the surface of the tube can be scanned in a helical manner, whereas, as described above, in the Pilger method the rolling process takes place discontinuously so that the surface is accordingly scanned in portions.

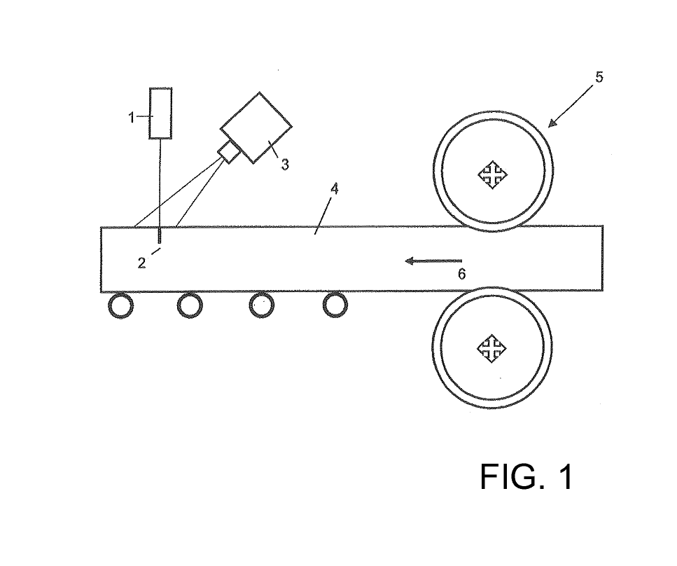

FIG. 1 shows the device for carrying out the method for monitoring the manufacturing process of hot-rolled tubes with the aid of the online detection of the topography of the surface by means of a two dimensional laser stripe method.

Within the framework of the method, a measurement uses a depiction of the surface of the tube 4, which is irradiated in a fan-like manner by a laser 1 as a projected laser line 2, on the detector formed as a camera 3. The tube 4 is in this case a Pilger tube which is rolled to nominal dimensions in the rolling stand 5 by means of two rolls by movement in the main rolling direction 6 and stepped rotation in the peripheral direction. In accordance with the invention, the recorded surface profile of the tube 4 is combined and evaluated by means of an evaluation unit, not illustrated, to form a topography, and from this deductions are made as to the process state.

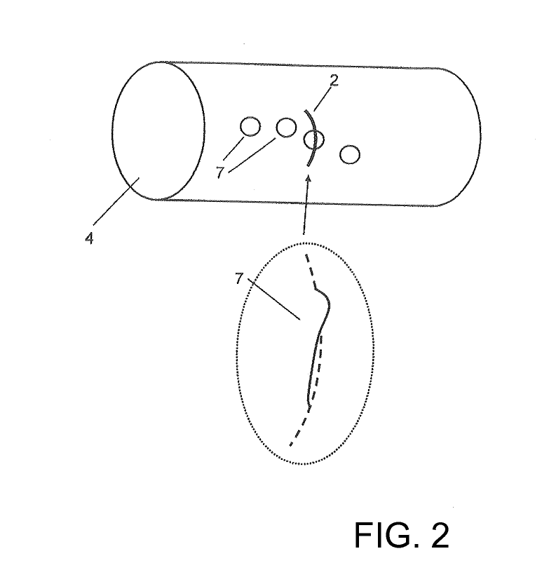

FIG. 2 shows a detail of detected surface structures on the tube surface, wherein these structures 7 constitute so called “Pilger humps” which have a regularity in shape, markedness and spacing with respect to each other and thus allow deductions to be made as to the process state. Profile lines recorded individually in a linear manner one after the other are combined as the tube continues to move—typically in a combination of axial and rotational movement—to form three-dimensional surface topographies.

By an analysis of the pattern and size of the recorded surface topographies in comparison with already known results stored in databases it is then possible to initiate remedial measures when boundary values are exceeded.

### REFERENCE LIST

1 laser

2 laser line

3 camera

4 tube

5 rolling stand

6 main rolling direction

7 structures on the tube surface

We claim:

1. A method for monitoring the manufacturing process of hot-rolled steel tubes in which the type and dimensional characteristics of structures produced by the rolling process on an outer surface of the tube are evaluated to assess the process state, said method comprising:
detecting the outer surface of at least one defined portion of the tube immediately subsequent to the rolling process in the exit side region of a rolling stand linearly by an optical laser stripe in a clocked manner in the form of profile lines;
combining the profile lines to form an at least two-dimensional topography; and
evaluating the topography to assess the process state.

2. The method of claim 1, wherein the hot-rolled steel tubes are produced by a hot Pilger process.

3. The method of claim 2, wherein the topography of the outer surfaces is detected in an automated manner.

4. The method of claim 3, wherein the outer surface of the tube is detected in a spatially-resolved and time-resolved manner, and wherein the topography composed there from is compared with a reference image of an already rolled tube, serving as a reference body, of the same steel grade class and same nominal dimensions of the same measurement location in each case and is evaluated to assess the process state.

5. The method of claim 4, wherein any structures arising on the surface of the tube are determined from a topography of the tube at a specific measurement location, and wherein the determined structures are compared with structures of a topography of the reference body for the same measurement location and a significant deviation between the structures is evaluated to assess the process state.

6. The method of claim 5, further including detecting the wall thickness on the rolled tube, determining the topography of the inner surface of the tube, and evaluating the inner surface topography to assess the process state.

7. The method of claim 6, wherein from a plurality of the topographies on the outer and/or inner surface, which are determined with the aid of reference bodies of the same steel grade class and nominal dimensions, a tolerance range for deviations is established, a signal being triggered if the boundaries of the tolerance range are exceeded.

8. The method of claim 7, wherein the signal is assigned to the measurement location on the tube and a reference to an event in the manufacturing process leading to the tolerance boundaries being exceeded is produced.

9. The method of claim 8, wherein the assignment of signal and event, which is determined in each case for the rolled tube, is stored in a database for each reference body of the same steel grade class and nominal dimensions, and, if the tolerance boundaries are exceeded at a certain measurement location, the event leading to the tolerance boundaries being exceeded is indicated and used as a control variable for the manufacturing process.

10. The method of claim 1, wherein the outer surface of the tube is detected in a spatially-resolved and time-resolved manner, and wherein the topography composed there from is compared with a reference image of an already rolled tube, serving as a reference body, of the same steel grade class and same nominal dimensions of the same measurement location in each case and is evaluated to assess the process state.

11. The method of claim 10, wherein any structures arising on the surface of the tube are determined from a topography of the tube at a specific measurement location, and wherein the determined structures are compared with structures of a topography of the reference body for the same measurement location and a significant deviation between the structures is evaluated to assess the process state.

12. The method of claim 1, further including detecting the wall thickness on the rolled tube, determining the topography of the inner surface of the tube, and evaluating the inner surface topography to assess the process state.

13. The method of claim 1, wherein from a plurality of the topographies on the outer surface, which are determined with the aid of reference bodies of the same steel grade class and nominal dimensions, a tolerance range for deviations is established, a signal being triggered if the boundaries of the tolerance range are exceeded.

14. The method of claim 13, wherein the signal is assigned to the measurement location on the tube and a reference to an event in the manufacturing process leading to the tolerance boundaries being exceeded is produced.

15. The method of claim 14, wherein the assignment of signal and event, which is determined in each case for the rolled tube, is stored in a database for each reference body of the same steel grade class and nominal dimensions, and, if the tolerance boundaries are exceeded at a certain measurement location, the event leading to the tolerance boundaries being exceeded is indicated and used as a control variable for the manufacturing process.
